(19) United States
(12) Patent Application Publication
(10) Pub. No.: US 2021/0284061 A1
(43) Pub. Date: Sep. 16, 2021

(54) IMPROVED HEAD LIGHTS OF A VEHICLE

(71) Applicant: Micron Technology, Inc., Boise, ID (US)

(72) Inventor: Alberto Troia, Munich (DE)

(21) Appl. No.: 16/625,233

(22) PCT Filed: Dec. 21, 2018
(86) PCT No.: PCT/IB2018/001464

§ 371 Date: Dec. 20, 2019

(51) Int. Cl. B60Q 1/50; B60Q 1/00; B60Q 1/04; G03B 21/00; G03B 21/20; F21S 41/36; H04N 9/31

(52) U.S. Cl. CPC B60Q 1/50; B60Q 1/0017; B60Q 1/0088; B60Q 1/04; F21W 2103/60; G03B 21/2033; F21S 41/36; H04N 9/3179; B60Q 2400/50; G03B 21/008

(57) ABSTRACT

The present disclosure relates to an apparatus and a method for projecting images and/or video data through the head lights of vehicles, especially head lights of assisted driving vehicles.

The apparatus comprises:
an entertainment system;
a head light having at least a Digital Light Processing (DLP) unit integrated therein;
a control unit configured to receive images and video data from the entertainment system and control the DLP unit to project at least an image and/or a video content through the head light.

### TECHNICAL FIELD

The present disclosure relates generally to apparatuses, systems and methods concerning vehicles. More particularly, the present disclosure relates to an apparatus that uses the head lights illumination of the vehicle.

### BACKGROUND

Motor vehicles, such as autonomous, partially autonomous and/or non-autonomous vehicles (e.g., automobiles, cars, trucks, buses, etc.), can nowadays use sensors, cameras, and communication means to obtain information about their surroundings.

Particularly, vehicle bead lights are becoming more and more interactive with pedestrian and another vehicle. For example, as the majority of accidents occur during night due to the limited visibility, the vehicle can be equipped with a system for controlling the orientation and intensity of the head lights to avoid glaring other vehicle or pedestrian and consequently improving safety during night.

However, the importance of the head lights is linked to the presence of a human inside the vehicle. Vehicles provided with autonomous driving system do not even need head lights as the vehicle uses different technologies to drive and this technical evolution would render head lights no longer necessary to let the vehicle drive during the night.

However, head lights are mandatory in the transition period from assisted driving vehicles to fully autonomous vehicles because the presence of the other non-autonomous vehicles has to be detected.

### BRIEF DESCRIPTION OF THE DRAWINGS

FIG. 1 shows a block diagram of an example vehicular entity, in accordance with an embodiment of the present disclosure;

FIG. 2 shows a vehicle having computing devices connected via a bus to share resources according to one embodiment of the present disclosure;

FIG. 3 shows a block diagram of an example a projecting apparatus for head lights of vehicles, in accordance with an embodiment of the present disclosure;

FIG. 4 shows a schematic view of a digital light projecting (DLP) unit of a projecting apparatus for head lights of vehicles, in accordance with an embodiment of the present disclosure;

FIG. 5 shows a schematic view of a digital light projecting (DLP) unit of a projecting apparatus for head lights of vehicles, in accordance with another embodiment of the present disclosure;

FIG. 6 is a front view of an example of a prior art head or front light of a vehicle incorporating regular lights for road illumination and/or travel indication purposes;

FIG. 7 is a front view of an example of head light of a vehicle incorporating a digital light projecting (DLP) unit of a projecting apparatus in accordance with an embodiment of the present disclosure;

FIG. 8 is another front view of an example of head light of a vehicle incorporating a digital light projecting (DLP) unit of a projecting apparatus in accordance with an embodiment of the present disclosure,

### DETAILED DESCRIPTION

With reference to those figures, apparatuses, systems and methods involving projecting multimedia content through the head lights of a vehicle will be disclosed herein.

In consideration of the fact that head lights have to be re-used in the transition period from assisted driving vehicles to fully autonomous vehicles for illumination purposes, it would be desirable to provide the head lights with additional functions such as the projection of information of multimedia content to rend them interactive for a better usage of the head lights.

The aim of the present disclosure is to satisfy the above-mentioned need, providing a projecting apparatus associated and/or incorporated in the head lights of vehicles, especially for head lights of assisted driving vehicles.

One embodiment of the invention relates to an apparatus comprising:
an entertainment system;
a head light having at least a Digital Light Processing (DLP) unit integrated therein;
a control unit configured to receive image and/or video data from the entertainment system and control the DLP unit to project an image and/or video content related to the image and/or video data through the head light.

In one embodiment, the entertainment system is associated to a vehicle computing device and is linked to said Digital Light Processing unit and to said DLP control unit through a fast connection data bus.

The DLP unit is further configured to project color images and/or a video content.

A further embodiment relates to a head light of a vehicle including:
at least a Digital Light Processing (DLP) unit;
a DLP control unit;
a data bus interconnecting said DLP unit and said DLP control unit and connecting both units to an entertainment system of the vehicle to receive images and/or video data.

In one embodiment, entertainment system includes a resident or a removable storage device including multimedia contents.

Moreover, said entertainment system is removably connected to the vehicle computing device through a fat-on connection of a data bus.

Another embodiment of the present invention relates to a method for projecting images and/or video data, comprising:
providing at least a Digital Light Processing (DLP) unit in the head light of a vehicle;
providing a DLP control unit to receive images and/or video data from an entertainment system of the vehicle and to control the DLP unit to project at least an image and/or a video content through the head light.

In one embodiment, said DLP unit takes the place of at least a normal light beam of a head light of the vehicle.

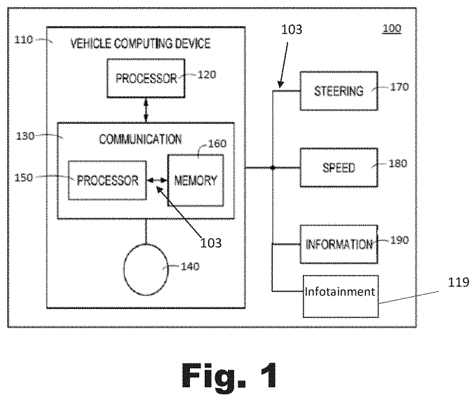

FIG. 1 is a block diagram of an example vehicular entity 100 according to an embodiment of the present disclosure. The vehicular entity 100 can be an autonomous vehicle, a traditional non-autonomous vehicle, an emergency vehicle, a service vehicle, or the like.

The vehicular entity 100 includes a vehicle computing device 110, such as an on-board computer. The vehicle computing device 110 includes a processor 120 coupled to a vehicular communication component 130, such as a reader, writer, and/or other computing device capable of performing the functions described below, that is coupled to (or includes) an antenna 140. The vehicular communication component 130 includes a processor 150 coupled to a memory 160, such as a non-volatile flash memory, although embodiments are not so limited.

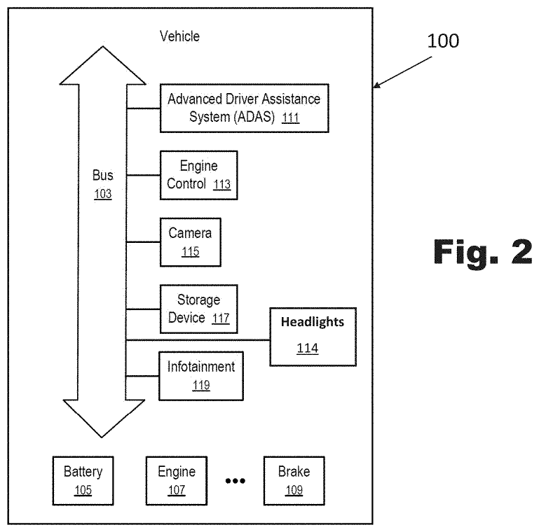

In particular, the memory 160 is adapted to store all the information related to the vehicle. Moreover, the vehicle computing device 110 can control operational parameters of the vehicular entity 100, such as steering and speed. For example, a controller (not shown) can be coupled to a steering control system 170 and a speed control system 180. Further, the vehicle computing device 110 can be coupled to an information system 190 and a further infotainment system 119. Information system 190 can be configured to display a message, such as the route information or a border security message and can display visual warnings and/or output audible warmings while the infotainment system 119 is dedicated to the managing of multimedia contents. The communication component 130 can receive information from additional computing devices, such as from external computing devices as schematically depicted in FIG. 2.

Moreover, the vehicle computing device 110 may be connected to the headlights 114 via a bus 103, as shown in FIG. 2.

At least one embodiment disclosed herein includes a vehicle 100 having multiple application boards connected to a storage device 160 via a bus 103, such as a PCIe bus, to share the storage capability of the storage device using virtual functions implemented in the storage device. The PCIe bus and/or the storage device can be used to facilitate communications among the vehicle application boards, such as a circuit board having components implementing a function of an advanced driver assistance system (ADAS), an infotainment system, an engine control, a camera, etc.

Conventional vehicle application boards, such as printed circuit boards having components installed there for the engine control, the braking system, the infotainment system, etc., are designed to operate independent from each other. Such vehicle application boards have their own local memory for storage of data and code in general. Some boards may have special purpose ports for add-on capabilities or capacities that extends the functionality of the boards.

For example, some boards may have ports configured to accept non-volatile memories, such as flash memory devices; and a flash memory device can be inserted into the port of such a board to extend the memory capability of the board.

For example, some hoards may have ports configured to accept Wi-Fi modules; and a Wi-Fi module can be inserted into the port of such a hoard to extend or enable the wireless local area network communication capability of the board.

In at least some embodiments disclosed herein, a PCIe bus 103 is provided on a vehicle to connect the vehicle application boards to one or more shared resources, such as storage devices. Thus, the cost of the boards can he optimized via the sharing of the unused storage capability of a single device among the boards that are connected to the PCIe bus in a vehicle.

For example, an application board may be manufactured with the minimum amount of memory installed; and the temporary data and/or infrequently used data can be stored in a shared data storage device, such as a Solid State Drive (SSD), that is connected to the PCIe bus. Thus, the storage capacity of one or more application boards installed on a vehicle can be extended through the provision of a shared storage device on the PCIe bus and/or enhanced via the upgrading of the shared storage device on the PCIe bus.

The PCIe bus 103 can be routed inside the vehicle to connect the application boards of the vehicle, as shown in FIG. 2. Further, the PCIe bus also allows the extension of the capability of the vehicle system by connecting more storage devices and/or other peripherals, such as cameras, sensors, data. processing units, tools, and gadgets for sharing by the application boards. When the additional peripherals and/or application boards are present on the bus, the software/firmware of the existing application boards can be upgraded or configured to extend their capabilities to provide new services based on communications and/or collaborations with the additional peripherals and/or boards. The peripherals and/or boards on the bus can communicate with each other (e.g., in the form of streams of data for read or -write operations) without a need for a separate computer network. The PCIe bus 103 can be used as a global bus between vehicle applications to communicate with each other (e.g., to exchange service messages among vehicle applications), share resources (e.g., front camera, rear camera, sensors, actuators). Thus, the bus provides the opportunity to interconnect different application boards and/or peripherals to provide advanced and/or integrated services and to improve the scalability of the in-vehicle computing system.

FIG. 2 shows a vehicle 100 having computing devices connected via. a bus 103 to share resources according to one embodiment.

A typical vehicle 100 has an engine 107, a brake 109, and other components for driving, steering, accelerating, stopping, etc. Some of the components may be controlled and/or monitored by one or more computing devices, such as an engine control 113, an advanced driver assistance system (ADAS) 111, an infotainment system 119, a storage device 117, a camera 115, etc.

For example, the advanced driver assistance system (ADAS) 111 may provide one or more features, such as Adaptive Cruise Control, Glare-Free High, Adaptive Light Control, Anti-Lock Braking, Automatic Parking, Automotive Navigation, Automotive Night Vision, Blind Spot Monitor, Pre-Crash Collision Avoidance, Crosswind Stabilization, Cruise Control, Driver Drowsiness Detection, Driver Monitoring, Electric Vehicle Warning Sounds, Emergency Driver. Assistant, Forward Collision Warning, Intersection Assistant, Hill Descent Control, Intelligent Speed Adaptation, Intelligent Speed Advice, Lane Departure Warning, Lane Change Assistance, Night Vision, Parking Sensor, Pedestrian Protection, Rain Sensor, Surround View, Tire Pressure Monitoring, Traffic Sign Recognition, Turning Assistant, Vehicular Communication; Wrong-Way Driving Warning, Autopilot, ProPilot Assist, etc.

In the present disclosure it has been considered that the other functions like Beam and Pixel Light and Swiveling Curve Lights have been incorporated into the headlights of the vehicle.

Some of the computing devices may have connected sensors to collect infoiniation related to the operation of the vehicle 100; and some of the computing devices may operate actuators to exert control on at least a portion of the vehicle 100. A battery 105 (and/or other power sources) provides power for the operations of the computing devices (111, 113, . . . , 119).

A computing device (e.g., 111, 113, . . . , 119) typically has a circuit board with components configured for a specific application. The application circuit board may have one or more microprocessors or microcontrollers, memory, software/firmware.

The computing device (e.g., 111, 113, . . . , 119) in the vehicle 100 are connected via a bus 103 for communication with each other and/or for sharing resources, such as the storage capacity of the storage device 117, the imaging capability of the camera 115, the processing power of the advanced driver assistance system (ADAS).

When the advanced driver assistance system (ADAS) 111 provides multiple features, the advanced driver assistance system (ADAS) can be implemented using multiple application boards that are connected to each other via the bus 103.

For example, the bus 103 can be implemented in accordance with predefined protocol specification., such as a specification for Peripheral Component Interconnect Express (PCI Express or PCIe) buses.

For example, the boards of the computing device (e.g., 111, 113, . . . , 119) may be connected in a chain via point to point serial connections.

For example, the boards of the computing device (e.g., 111, 113, . . . , 119) may be connected via point to point serial connections to one or more switches and/or a root complex to form the bus 103.

Connecting the computing device (e.g., 111, 113, . . . , 119) via the bus 103 allows the application boards to share resources and/or communicate with each other, directly or indirectly via the storage device 117.

For example, When the advanced driver assistance system (ADAS) has multiple application boards implementing multiple features, the application boards can be connected to the bus 103 to share the storage capacity of the storage device 117 and/or other peripheral resources, such as the camera 115, sensors, etc. Thus, different combinations of feature sets can be implemented via connecting selected boards to the bus 103.

Virtualization can be implemented to allow a degree of separations of different application hoards that share a certain resource, such as the storage device 117. For example, Single Root Input/Output Virtualization (SR-IOV) and/or Multi Root Input/Output Virtualization (MR-IOV) can be used to facilitate sharing where the different applications are separated via virtual functions implemented in the shared hardware device, such as the storage device 117.

For example, the storage device 117 may present on the bus 103 a plurality of virtual functions of the storage device 117. Each virtual function of the storage device 117 is configured on a portion of the storage capacity of the storage device 117. Different virtual functions of the storage device 117 are assigned for use by different application boards. Thus, the operations of the application boards are substantially separate from each other, even though the application boards share the same storage device 117.

Alternatively, the storage device 117 may implement multiple physical functions that are assigned for use by different application boards. However, implementing multiple physical functions increases the cost and reduces the flexibility in accommodating a varying number of application boards that can be connected for shared access to the storage device 117.

In some instances, multiple physical functions are implemented in the storage device 117 to improve the processing capability of the storage device 117; and virtual functions supported by the physical functions are assigned to the application boards. Thus, the application boards do not use the physical functions directly.

In one embodiment of the present disclosure, according to the present disclosure, the vehicle 100 includes a vehicle-mounted projection apparatus 200 that uses the head lights illumination of the same vehicle for projecting multimedia. contents.

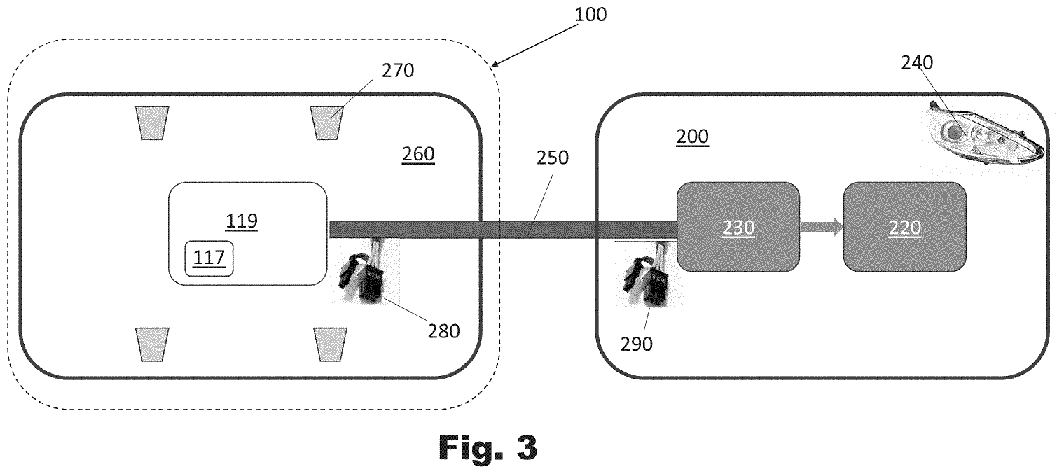

FIG. 3 is a block diagram of an example of such a projecting apparatus 200 to be incorporated into a head light of a vehicle and connected to the infotainment system 119 of the vehicle, in accordance with an embodiment of the present disclosure.

The projecting apparatus includes a digital light processing (DLP) unit 220 in communication with control unit 230. The DLP unit 220 and the control unit 230 may be incorporated into a head light 240 as it will be better explained below. As an alternative, only the DLP unit 220 may be incorporated into the head light while the control unit 230 may be installed in the vehicle computing device 110. The DLP unit is further configured to project color images and/or a video content.

The DLP unit 220 is connected to the control unit 230 and to the infotainment system 119 through a bus 250. The bus 250 can be implemented in accordance with predefined protocol specification, such as specification for Peripheral Component Interconnect Express (PCI Express or PCIe) buses.

In other words, the bus 250 may correspond to the bus 103 previously disclosed or may be a local bus as a peripheral branch of that bus 103. As an alternative, the bus 250 may be structured like the bus 103 but with opposite plug-in connectors 280, 290 to connect directly the infotainment system 119 with the control unit 230.

The plug-in connectors may be a six plus two pins PCIe connector or a eight pins PCIe connector that is mounted on the opposite ends of the data bus 250. In the Figure it is shown. a male connector just as an example. This kind of fast-on connector may be used for removably connecting in a fast manner the data bus 250 to a corresponding female connector associated to the DLP unit 220 of the head light and to the DLP control unit 230. Similarly, this kind of male or female PCIe connectors may be associated to an output of the infotainment system 119 for a fast-on connection with the data bus 250.

The infotainment system 119 can be mounted into the cabin 260 of the vehicle and connected to speakers 270 also mounted into the cabin 260. The infotainment system 119 may include a storage device 117. In FIG. 3 it is schematically shown that the cabin is included in the vehicle 100.

In one embodiment, the entertainment system includes a resident and removable storage device 117 including multimedia contents.

The use of the virtual functions of the storage device 117 provides the flexibility in partitioning the resources for sharing by a varying number of application boards, and the flexibility in assigning varying amounts of storage resources to different application boards.

More particularly, as it will be described into details in the following, an example of projecting apparatus 200 includes the digital light processing (DLP) unit 220 and the DLP control unit 230 configured to receive information and/or multimedia data and control the DLP unit 230 to project an information and/or multimedia content related to the information and/or multimedia data through the head light 240 of the vehicle 100.

In at least one embodiment, the DLP unit 230 and the DLP control unit 220 are both incorporated into the head light 240 of the vehicle 100.

As an alternative, the DLP control unit 230 may be incorporated in the vehicle computing device 110.

In at least one embodiment, the DLP control unit 230 is in communication with the infotainment system 119 to receive multimedia data from the infotainment system. In at least one embodiment, the infotainment system 119 is mounted into the vehicle cabin.

In at least one embodiment, the DLP control unit 230 is connected to the entertainment system 119 and to the DLP unit 220 through a PCIe bus 250.

Disclosed herein is also a head light 240 including a digital light processing (DLP) unit and a DLP control unit configured to receive information and/or multimedia data and control the DLP unit to project an information and/or multimedia content related to the multimedia data through the head light.

In one embodiment of the present disclosure, by introducing a projection apparatus 200 including a DLP unit 220 and a corresponding control unit 230 into the head lights 240 of a vehicle 100, a projection of any desirable information or multimedia content related to information and/or multimedia data. stored into a memory device can be achieved through the head lights. In this way, head lights 240 are rendered interactive while accomplishing their normal illumination purpose.

For instance, the headlight 240 can also integrate additional component such as a camera that can project real time images in front of the vehicle, i.e. implement of high definition object recognition. An example can be pointing an animal in front of the vehicle and to show an enlarged view of this animal using the projector in one of the headlights and/or in the other one of the headlights to show the animal to a child on board on the vehicle.

Disclosed herein is also a method implemented into a vehicle comprising the steps of providing a DLP unit 220 and a DLP control unit 230 connected to each other through a bus 250 for projecting multimedia contents from the head lights 240 of the vehicle 100.

However, it should be noted that although the present disclosure will refer to embodiments of the projection apparatus and method for head lights of a vehicle, the present disclosure is not limited thereto.

More particularly, the solution of the present disclosure may be applied to both front lights 114; in this manner the dual DLP projectors in front of the vehicle can serve:
during driving as lamps for illumination purposes, but using specific colors not only with monochromatic light;
during the parking of the vehicle to project specific content from the infotainment system; for instance, it would be possible to project a movie or to find the vehicle in a parking lot;
as a regular projector to project personal movies and/or streamed movies from the lights toward a visible surface like a wall.

The dual DLP head light can operate in a 3D mode, depending on the screen in front, or in holographic personal mode, depending on the around environment. All in all, the vehicle may be transformed in a sort of personal “drive-in” for the projection of movies selected by the user. In other words, the user can download the streaming from internet and/or using personal videos to drive the head lights.

The DLP control unit 230 either the head lights can be unique and can receive data from the infotainment system 119 through the bus 250.

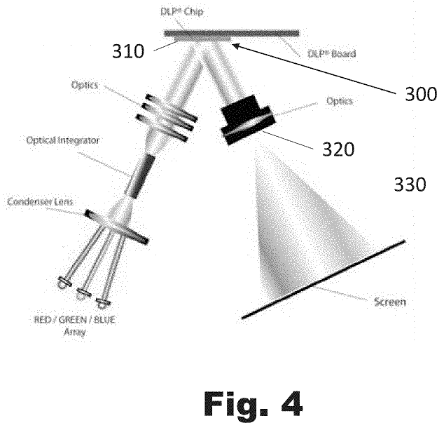

Making now reference to the example of FIG. 4, it will be disclosed a semiconductor component 300 of the DLP unit 220. A Digital Light Processing (DLP) is a display device based on optical micro-electro-mechanical technology that uses a digital micromirror device.

DLP is used in a variety of display applications from traditional static displays to interactive displays and also non-traditional embedded applications including medical, security, and industrial uses.

In DLP projectors, the image is created by microscopically small mirrors laid out in a matrix on a semiconductor chip 310, known as a Digital Micromirror Device (DMD).

A typical DMD array has thousands of mirror elements suspended over a substrate, Electrostatic attraction between the mirror and an address electrode causes the mirror to twist or pivot, in either of two directions, about an axis formed by a pair of torsion beam hinges. Typically, the mirror rotates about these hinges until the rotation is mechanically stopped, The movable micro-mirror tilts into the on or off states by electrostatic forces depending on the data written to the cell. The tilt of the mirror is on the order of plus 10 degrees (on) or minus 10 degrees (off) to modulate the light that is incident on the surface.

In more details, the semiconductor chip 310 uses reflections from a large array of micro-mirrors (about one million), each mounted above its own semiconductor memory cell and referred to herein as a DMD (digital micro-mirror device). The DMD comprises a special light modulator that covers each memory cell of a CMOS static RAM with a movable tiny, substantially square or diamond shaped mirror having an edge dimension on the order of about few micrometers. Each mirror represents one or more pixels in the projected image. The number of mirrors corresponds to the resolution of the projected image. Electrostatic forces controlled by the data in this cell tilt each of the mirrors around a pair of axes either plus or minus about 10° degrees, so as to modulate the light incident on the surface of the mirror.

Other types of image display systems typically create images by emitting or modulating light so that the light forms an array of picture elements, or pixels, which when viewed together form an image. While most light modulators can create multiple intensity levels, a true digital light modulator, such as the DMD cannot. The light reflected from selected ones of the mirrors passes through a projection lens 320 and creates an image on a screen 330.

Light from the remaining off or non-selected mirrors is reflected away from the projection lens and trapped. Without the capability to create multiple brightness levels, digital light modulators such as the DMD array rely on a digital pulse-width modulation scheme to create various intensity levels by turning a modulator element on and off very rapidly.

The portion of time during each video frame that the mirror remains in the on state determines the shades of gray (or color intensity) from black, for zero percent on time, to white, (or bright color) for un hundred percent on time. Color may be added by a color wheel or by using two or more DMD's to control or turn a selected set of primary colors on and off.

DLP technology is light-source agnostic and as such can be used effectively with a variety of light sources.

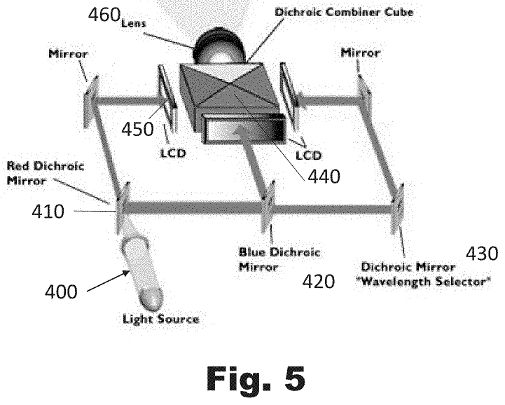

FIG. 5 shows an alternative example of DLP projector wherein a light source 400 focuses its light toward a first dichromic mirror 410 splitting a primary red color light beam and deviating the remaining beam toward another dichromic mirror 420 splitting another blue color light beam and deviating a further beam portion toward a further dichromic mirror 430.

In this example a three-chip DLP projector uses a prism 440 to split light from the light source 400, and each primary color of light is then routed to its own DLP chip 450, then recombined and routed out through the lens 460. Three chip systems are found in higher-end home theater projectors, large venue projectors and DLP Cinema projection systems found in digital movie theaters.

A further alternative of DLP display that may be implemented in the head lights of the present disclosure and which also eliminated the use of a color wheel is based on laser technology. Three separate color lasers illuminate the digital micromirror device (DMD) producing a richer, more vibrant color palette than other methods.

Another alternative implementation may use a handheld projector (also known as pica projector or mini Beamer) is an image projector in a handheld device. Handheld projectors involve miniaturized hardware, and software that can project digital images onto a nearby viewing surface.

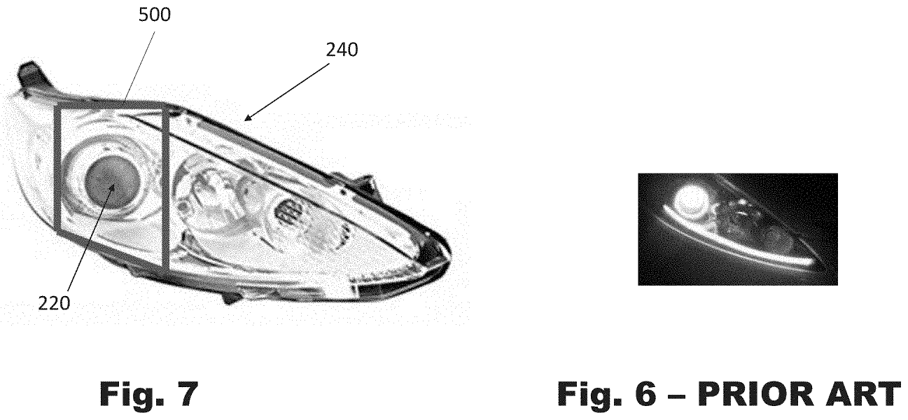

In any case, independently from the technology adopted to implement the DLP unit 220, the present disclosure teaches to host such a DLP unit 220 in a front head light 240 of a vehicle, in particular in substitution of a normal side beam for instance the one shown in the prior art picture of FIG. 6.

FIG. 7 shows a non-limiting example of an area 500 identified in the external side portion of a head light of a vehicle wherein the DLP unit 220 of the present disclosure may be mounted.

In this example the DLP unit takes the place of a normal side beam of the head light and its structure may correspond to the lens 320 or 460 of the examples shown in the FIG. 4 or 5.

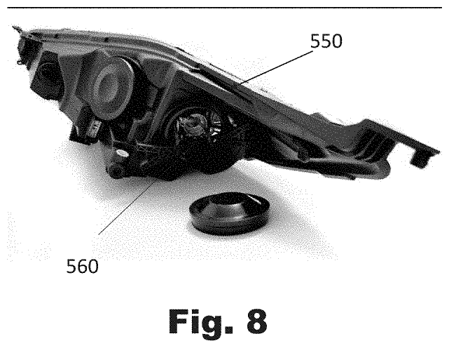

FIG. 8 shows the internal supporting structure of the head light 240 of FIG. 7 with the protection glass removed and with a supporting plastic frame 550 including a recessed side portion 560 for hosting the DLP unit to be connected to the DLP control unit through the data bus 250.

In other words, the DLP unit takes the place of at least a normal light beam of a head light of the vehicle.

According to the invention, a head light of an existing vehicle may be modified by at least substituting a normal beam with a DLP projector, connecting such a projector to a DLP control unit and an entertainment system of the vehicle. In one embodiment, the interconnection among the above components may be implemented through the data bus 103 and corresponding fast-on connectors,

Moreover, the changes to the headlight of a vehicle in accordance with the present disclosure would allow to introduce a method for establishing a vehicle-to-vehicle communication using the headlights. For instance, in case of missing of other alternative communication means, the drivers of two close vehicles could communicate by using the DLP control unit and the projectors in the headlights to exchange visual information, for instance a simple warning message.

Therefore, the implementation of a visual mechanism previously disclosed would allow to re-use the head lamps for a better usage, in particular the head lamps of the autonomous vehicle since all future vehicle provided with autonomous driving system would not even need head lights.

The previously disclosed solution is mandatory in the transition from driver assisted mechanism to fully autonomous vehicles.

Moreover, the implementation of colored visual indication in front of the vehicle would also allow to project warning signals or to exchange visual information between vehicles.

With the solution of the present disclosure it is possible to project 3D and holographic personal content in front of the vehicle for any possible entertainment use.

The system disclosed herewith may even be considered a sort of personal drive-in concept using a single vehicle and may even establish a trend.

In the preceding detailed description, reference is made to the accompanying drawings that form a part hereof, and in which is shown, by way of illustration, specific examples. In the drawings, like numerals describe substantially similar components throughout the several views. Other examples may be utilized, and structural, logical and/or electrical changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and eliminated so as to provide a number of additional embodiments of the present disclosure. In addition, as will be appreciated, the proportion and the relative scale of the elements provided in the figures are intended to illustrate the embodiments of the present disclosure and should not be taken in a limiting sense.

As used herein, “a,” “an,” or “a number of’ something can refer to one or more of such things. A “plurality” of something intends two or more. As used herein, the term “coupled” may include electrically coupled, directly coupled, and/or directly connected with no intervening elements (e.g., by direct physical contact) or indirectly coupled and/or connected with intervening elements. The term coupled may further include two or more elements that co-operate or interact with each other (e.g., as in a cause and effect relationship).

Although specific examples have been illustrated and described herein, those of ordinary skill in the art will appreciate that an arrangement. calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. The scope of one or more examples of the present disclosure should be determined with reference to the appended claims, along with the full range of equivalents to which such claims are entitled.

1-30. (canceled)

31. An apparatus, comprising:
an entertainment system in a vehicle;
a head light having at least a Digital Light Processing (DLP) unit integrated therein; and
a control unit configured to receive images, video data, or both from the entertainment system and control the DLP unit to project at least an image or a video content, or both, through the head light.

32. The apparatus of claim 31, wherein the entertainment system is associated to a vehicle computing device and is linked to the Digital Light Processing unit and to the DLP control unit through a fast connection data bus.

33. The apparatus of claim 32, wherein the entertainment system is removably connected to the vehicle computing device through a fat-on connection of a data bus.

34. The apparatus of claim 31, wherein the DLP unit and the DLP control unit are both incorporated into the head light of the vehicle.

35. The apparatus of claim 31, wherein the DLP unit is associated to the entertainment system while the DLP control unit is incorporated into the head light of the vehicle.

36. The apparatus of claim 31, wherein the (DLP) unit includes a display device based on optical micro-electro-mechanical technology that uses a digital micromirror device, or a laser technology, or both.

37. The apparatus of claim 31, wherein the entertainment system includes a resident storage device or a removable storage device, or both, including multimedia contents.

38. The apparatus of claim 31, wherein the DLP unit is configured to project color images or video content, or both.

39. A head light of a vehicle, comprising:
a Digital Light Processing (DLP) unit, and
a bus connector to fast connect the DLP unit to a DLP control unit through a data bus, wherein
the DLP control unit is configured to receive images, video data, or both, from an entertainment system of the vehicle.

40. The head light of claim 39, wherein the DLP unit and the DLP control unit are both incorporated into the head light of the vehicle.

41. The head light of claim 39, wherein the DLP unit is incorporated into the head light of the vehicle while the DLP control unit is associated to the entertainment system.

42. The head light of claim 39, wherein the DLP unit and the DLP control unit are both connected through the data bus to the entertainment system.

43. The head light of claim 42, wherein the connecting data bus is implemented in accordance with predefined protocol specification.

44. The head light of claim 39, wherein the DLP unit comprises a display device based on optical micro-electro-mechanical technology that uses a digital micromirror device.

45. The head light of claim 39, wherein the DLP unit comprises a display device based on laser technology.

46. The head light of claim 39, wherein the DLP unit is configured to project color images, video content, or both.

47. A method, comprising:
providing at least a Digital Light Processing (DLP) unit in a head light of a vehicle; and
providing a DLP control unit to:
receive images, video data, or both, from an entertainment system of the vehicle; and
control the DLP unit to project at least an image, a video content, or both, through the head light.

48. The method of claim 47, further comprising providing a second DLP unit in a second head light of the vehicle.

49. The method of claim 47, further comprising providing a fast connection data bus between the entertainment system of the vehicle and the DLP unit and the DLP control unit.

50. The method of claim 47, further comprising providing an entertainment system including a resident storage device, a removable storage device, or both, including multimedia contents.

51. The method of claim 50, wherein the entertainment system of the vehicle is removably connected to the vehicle computing device through a fast-on connection of a data bus.

52. The method of claim 47, wherein the DLP unit takes the place of at least a normal light beam of the head light of the vehicle.

53. The method of claim 47, wherein the DLP unit is configured to project an image, a video content, or both, during parking of the vehicle and is configured to operate as a regular interactive lamp during driving.

54. The method of claim 47, wherein the DLP unit is configured to project color images, a video content, or both.
